(19) United States
(12) Patent Application Publication
(10) Pub. No.: US 2014/0082215 A1
(43) Pub. Date: Mar. 20, 2014

(54) ARBITRATING BETWEEN DATA PATHS IN A BUFFERLESS FREE FLOWING INTERCONNECT

(71) Applicants: Andrew David TUNE, Dronfield (GB); Sean James SALISBURY, Appley Bridge (GB); Sean Tristam ELLIS, Farnham (GB)

(72) Inventors: Andrew David TUNE, Dronfield (GB); Sean James SALISBURY, Appley Bridge (GB); Sean Tristam ELLIS, Farnham (GB)

(73) Assignee: ARM LIMITED, Cambridge (GB)

(21) Appl. No.: 13/622,432

(22) Filed: Sep. 19, 2012

(51) Int. Cl. H04L 12/56

(52) U.S. Cl. CPC H04L 45/00
USPC 709/240

(57) ABSTRACT

An interconnect comprising paths configured to transmit data packets between nodes on a network. The nodes comprise ports for inputting and outputting the data packets to the interconnect. At least two of the paths each have at least a portion configured such that a data packet addressed for output at one of the nodes on one of the paths and not being accepted at the node will continue along the path and on travelling further will return to the node. The at least two paths are balanced paths such that a data packet not accepted at the one of the nodes will return to the node a same predetermined number of clock cycles later whichever of the balanced paths the data packet is traveling along. The one of the nodes comprises an arbiter that is configured to prioritise one of the balanced data paths for output, the arbiter being configured to ensure that a priority changes after the predetermined number of clock cycles, such that a data packet on any of the balanced paths not being accepted for output at the node on a first attempt is guaranteed to have priority on a subsequent return to the node.

### TECHNICAL FIELD

The technical field relates to the field of interconnects and in particular, to bufferless free flowing interconnects having multiple data paths, and to the arbitration between these data paths at an output where there is contention between data packets on different paths.

### BACKGROUND

Bufferless networks are known where contending messages if they are not selected at a point of contention are either dropped and then retransmitted later by their source or are deflected and routed further along a path that will return to the point of contention. These networks work well in situations where they are sufficiently lightly loaded that the dropping or misrouting of messages occurs infrequently enough, so that there is only a small impact on performance.

One example of a bufferless network is a ring network in which there are two rings, bus0 and bus 1 which transmit messages in opposite directions and have an equal number of pipeline stages. These networks are often called dynamic free-flowing balanced ring interconnects and an example of one is shown in FIG. 1.

In such an interconnect, a message or data packet can only exit the ring if the receiving node has availability. If this is not possible, for example the node may be dealing with a packet on the other data path, the packet may be misrouted and be sent around the ring again whereupon on arrival back at the node it will try to exit again.

Such networks are by their nature free from deadlock as no message can wait, they can however experience livelock where one data packet never has priority to exit and is transmitted around the ring indefinitely.

One known way of addressing this problem is to promote rejected packets to a new class such that they will have priority a subsequent time and are guaranteed to be accepted in preference to non-promoted packets. A disadvantage of this is that the packets need to be both manipulated and inspected which has both power and performance overheads. Furthermore, additional information is added to the packet which has bandwidth overheads.

It would be desirable to be able to avoid livelock situations in a free flowing bufferless interconnect without manipulating or inspecting the data packets.

### SUMMARY

A first aspect provides an interconnect comprising paths configured to transmit data packets between nodes on a network, said nodes comprising ports for inputting and outputting said data packets to said interconnect;

at least two of said paths each having at least a portion configured such that a data packet addressed for output at one of said nodes on one of said paths and not being accepted at said node will continue along said path and on travelling further will return to said node;

said at least two paths being balanced paths such that a data packet not accepted at said one of said nodes will return to said node a same predetermined number of clock cycles later whichever of said balanced paths said data packet is traveling along;

said one of said nodes comprising an arbiter configured to prioritise one of said balanced data paths for output, said arbiter being configured to ensure that a priority changes after said predetermined number of clock cycles, such that a data packet on any of said balanced paths not being accepted for output at said node on a first attempt is guaranteed to have priority on a subsequent return to said node.

The present invention recognises that if you are aware of how many cycles it will take a data packet that has been rejected at a node to arrive back at that node, then by configuring the arbiter such that it ensures that the priority of the data paths has changed after this number of cycles, you can be sure that when the data packet arrives back at the node the data path with priority for output is a different data path to that when it was previously there. In this way without any need to either inspect or manipulate the data packets the data path priorities can be changed such that a data packet will see a different priority on arrival back at the output node and this can be used to avoid livelock. The inspection and manipulation of data packets puts additional logic into the data packet path which increases delays to the system and where data is added to the data packet increases the bandwidth of the packets, thus it is highly advantageous to be able to prevent livelock without inspecting or manipulating data packets.

In effect the data path priorities will change in synchronisation with the travel of the data packet, such that when it arrives back at the node the priority will have changed. In the case of two paths the data packet will be output the next time it arrives at the node. If there are more paths it may take longer for the path it is on to have the highest priority.

In some embodiments each of said balanced paths comprises a same predetermined number of nodes.

For paths to be balanced it must take data packets travelling along each of the paths the same amount of time to arrive back at a shared node. Many balanced paths have the same number of nodes on them as generally the time taken to travel along a path is dependent upon the time it takes to travel through a node. It may be that the balanced paths are travelling to the same nodes perhaps in different directions.

In some embodiments said arbiter comprises a data store for storing an indicator indicating which of said balanced paths has priority for outputting a data packet, said arbiter being configured to update said indicator to indicate each of said balanced paths in a round robin manner, such that said indicator will indicate a next balanced path in said round robin list after said predetermined number of clock cycles.

The arbiter may store an indicator which indicates which of the balanced paths has priority. This will be required where there are more than two balanced paths. In such a case it is important that the arbiter cycles through each of the balanced paths as it updates the path indicators as this will ensure that each path will have the highest priority at a certain point. A simple way to do this may be the round robin way and this will simply ensure that each path has priority on a rota type arrangement.

In some embodiments, said interconnect comprises two balanced paths, wherein a data packet on one of said two balanced paths not being accepted for output at said node on a first attempt is guaranteed to have priority on a first return to said node.

Where there are two balanced paths then the priority simply toggles between the two paths such that if the data packet is not output at the first attempt it will be output at the next attempt. In this way no data packet will have to travel the whole way back to the node more than once.

In some embodiments, said arbiter comprises a data store for storing an indicator indicating which of said two balanced paths has priority, said predetermined number of nodes being an odd number and said arbiter being configured to toggle said indicator between receipt of each data packet.

Where the number of nodes is an odd number of nodes the arbiter can simply toggle the indicator between receipt of each data packet as this will ensure that as the number of nodes is odd to the other data paths when a data packet returns back to that node.

In some embodiments, said predetermined number of nodes is an even number N, and said arbiter is configured to toggle said indicator between receipt of all but one of every N data packets.

Where the number of nodes is an even number then the arbiter could be configured to toggle the indicator between receipt of all but one of every N data packets. In other words once during the N data packets travelling back to the node the arbiter will not toggle the priority of the data path at the node. This will ensure that when a data package arrives back at the node the priority will be different to when it was at the node last time.

In some embodiments said interconnect comprises a signal path balanced with said balanced data paths such that a signal transmitted from said one of said nodes will return to said node said predetermined number of clock cycles later, said arbiter being configured to change a priority of said balanced paths in dependence upon a value of said signal.

In some embodiments a signal path that is balanced with the balanced data paths is added to the interconnect. One can be sure that a signal transmitted from one of the nodes will return to that node the predetermined number of clock cycles later and therefore by monitoring this signal one knows when the predetermined number of clock cycles has occurred and the priority should therefore be changed. Thus, the value of this signal can be used by the arbiter to determine when the predetermined number of clock cycles has passed and therefore when the priority of the balanced paths should be changed.

In some embodiments, said signal path comprises a counter configured to count to a value equal to a number of said balanced data paths, said counter updating every predetermined number of clock cycles, a value of said signal indicating said data path to have priority.

Where there are more than two balanced data paths then it may be advantageous to have a counter on the signal path that counts to a value equal to a number of the balanced data paths such that the value of the counter indicates which of the data paths should currently have priority. Provided the counter is updated every predetermined number of clock cycles then this will ensure that the priority is changed in the correct manner.

In some embodiments, said arbiter comprises a data store for storing an indicator indicating which of said balanced paths has priority for outputting a data packet, said arbiter being configured to update said indicator to indicate each of said balanced paths in a round robin manner, such that said indicator will indicate a next balanced path in said round robin list after said predetermined number of clock cycles;

said signal path comprises register stages for holding said signal, said interconnect being configured to preload said register stages with an initial value that is transmitted along said signal path, said arbiter being configured to update said indicator in dependence upon said signal value on said signal path, said initial value being selected such that every predetermined number of clock cycles, said arbiter changes a priority of said balanced data path.

An alternative way of addressing plural data paths is to have an indicator within the arbiter itself which indicates each of the balanced paths in a round robin manner and which is updated in response to the signal on the signal path. One way of doing this is to pre-load the register stages on the signal path with an initial value that is selected such that the arbiter can determine from a particular change in the signal value that a predetermined number of clock cycles has passed and the indicator should be updated.

For example, said initial value could comprise a plurality of consecutive predetermined values, and at least one complementary predetermined value said arbiter updating said indicator in response to said signal switching to one of said predetermined or complementary predetermined value such that it updates once every predetermined number of clock cycles.

The initial value may be a set of consecutive ones followed by a set of consecutive zeros, it should be noted that there may be only one one or one zero but that the values should not be intermingled. If such a pattern of values is chosen then the change from a zero to a one or the change from a one to a zero will occur once every predetermined number of cycles and the arbiter may use the detection of this change to trigger an update of the indicator.

In some embodiments, said interconnect comprises two balanced paths, wherein a data packet on one of said two balanced paths not being accepted for output at said node on a first attempt is guaranteed to have priority on a first return to said node; and

said signal path is configured to transmit a signal that changes value every predetermined number of clock cycles said arbiter being configured to select one of said two balanced data paths to have priority in dependence upon a value of said signal.

Where there are only two balanced paths the signal path may simply transmit a signal that changes value every predetermined number of clock cycles and the balanced data path can be selected in dependence upon the value of this signal.

In some embodiments, the signal path comprises an inverting device that is configured to convert said signal at one point in said signal path.

One way of changing the value of the signal is to insert an inverting device such as an inverter in the signal path. In this way at one point on the path the signal will to change value and as it takes the predetermined number of clock cycles to travel around the path this will occur every predetermined number of clock cycles.

In some embodiments, said interconnect comprises a free flowing ring network and said two balanced paths are parallel paths transmitting packets in opposite directions between a same set of nodes around said ring.

Although the balanced paths may be arranged in a number of ways, they may be a free flowing ring network with two balanced paths in parallel that transmit packets in opposite directions. In such an arrangement there may be an arbiter at each node selecting data packets to output. Alternatively, there may be an arbiter at only some of the nodes, as it may only be a subset of the nodes where contention may occur.

In some embodiments, said interconnect comprises a k-ary n-cube network, comprising an n dimensional grid with k nodes in each dimension and channels between nearest neighbours, one of said two balanced rings interconnecting said other of said two balanced rings at at least one node.

In some embodiments, said interconnect comprises a 2-dimensional torus network, one of said two balanced rings interconnecting said other of said two balanced rings at at least one node, said at least one node comprising said arbiter.

In other embodiments, said interconnect comprises a k-ary, n-mesh.

Embodiments of the present invention are applicable to interconnects which have balanced data paths where a data packet that is not output at a first attempt can be transmitted further and will arrive back at the node which refused its output the first time. Such balanced paths may be formed in a plurality of different sorts of interconnects some of which are listed above.

A second aspect of the present invention provides an arbiter configured to select one of at least two data paths at a node on a network for outputting a data packet from, said node comprising ports for inputting and outputting data packets to one of said at least two data paths, each of said at least two data paths having at least a portion configured such that a data packet addressed for output at said node on any of said at least two data paths and not being accepted for output at said node will continue along said data path and on travelling further will return to said node;

said at least two data paths being balanced paths such that a data packet not accepted at said node will return to said node a same predetermined number of clock cycles later whichever of said balanced paths said data packet is traveling along;

said arbiter comprising prioritising circuitry for prioritising one of said data paths for output, said prioritising circuitry being configured to change a priority after said predetermined number of clock cycles, such that a data packet on either of said balanced paths not being accepted for output at said node on a first attempt is guaranteed to have priority on a subsequent return to said node.

The present invention recognises that an arbiter that can prioritise a data path in a manner dependent upon a predetermined number of clock cycles and independent of the data packet itself means that the prioritising of data paths can be implemented without the need to manipulate or inspect the data packets which leads to power efficient and area efficient prioritisation.

In some embodiments, said arbiter comprises a data store for storing an indicator indicating which of said balanced paths has priority for outputting a data packet, said arbiter being configured to update said indicator to indicate each of said balanced paths in a round robin manner, such that said indicator will indicate a next balanced path in said round robin list after said predetermined number of clock cycles.

Where there are several data paths then the arbiter should have an indicator indicating which of the balance paths has priority. This indicator being updated in a round robin manner such that each path will have priority at some point thereby avoiding live lock situations where data packet is on a path that never has priority.

In some embodiments said arbiter is configured to select one of two balanced paths said arbiter further comprising:

an input for inputting a number of nodes N in said balanced data paths and being configured:

if said number N is an odd number to toggle said indicator indicating which of said two balanced paths has priority between receipt of each data packet; and

if said number N is an even number to toggle said indicator between receipt of all but one of N data packets.

One way of determining when the predetermined number of cycles has passed is by determining when a certain number of data packets that is equal to the number of nodes on the balance data path has passed. Where the number of nodes is an odd number then one can ensure that after the predetermined number of cycles the value has changed by simply toggling after each data packet. Where the number is even then one can toggle after each data packet provided that once during N data packets one does not toggle.

In some embodiments, said arbiter comprises an input for receiving a signal from a signal path that is balanced with said balanced data paths such that a signal transmitted from said one of said nodes will return to said node said arbiter being configured to change a priority of said balanced paths in dependence upon said signal on said signal path.

An alternative way of determining when the predetermined number of clock cycles has passed is by receiving an input from a signal path that is balanced with the balanced data paths. When this signal has travelled around the balanced signal path then one knows that data on the balanced data paths will also have travelled around these paths.

A third aspect of the present invention provides a method of selecting one of at least two data paths at a node on a network for outputting a data packet from, said node comprising ports for inputting and outputting data packets to one of said at least two data paths, each of said at least two data paths having at least a portion configured such that a data packet addressed for output at said node on any of said at least two data paths and not being accepted for output at said node will continue along said data path and on travelling further will return to said node;

said at least two data paths being balanced paths such that a data packet not accepted at said node will return to said node a same predetermined number of clock cycles later whichever of said balanced paths said data packet is traveling along;

said method comprising the steps of:

prioritising one of said data paths for output;

changing a priority after said predetermined number of clock cycles, such that a data packet on either of said balanced paths not being accepted for output at said node on a first attempt is guaranteed to have priority on a subsequent return to said node.

A fourth aspect of the present invention provides interconnecting means comprising paths for transmitting data packets between nodes on a network, said nodes comprising inputting and outputting means for inputting and outputting said data packets to said interconnecting means;

at least two of said paths each having at least a portion configured such that a data packet addressed for output at one of said nodes on one of said paths and not being accepted at said node will continue along said path and on travelling further will return to said node;

said at least two paths being balanced paths such that a data packet not accepted at said one of said nodes will return to said node a same predetermined number of clock cycles later whichever of said balanced paths said data packet is traveling along;

said one of said nodes comprising an arbiter means for prioritising one of said balanced data paths for output, said arbiter means ensuring that a priority changes after said predetermined number of clock cycles, such that a data packet on any of said balanced paths not being accepted for output at said node on a first attempt is guaranteed to have priority on a subsequent return to said node.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 shows an example of a bufferless free flowing ring network;

FIG. 2a shows an example of a bufferless free flowing ring network according to an embodiment of the present invention;

FIG. 2b shows arbitration selection sequences for a two data path network with different number of shared nodes;

FIG. 3 shows an arbiter according to an embodiment of the present invention;

FIG. 4 shows a bufferless ring network having an additional signal line according to an embodiment of the present invention;

FIG. 5 shows an arbiter configured to update in response to a value on a signal line according to an embodiment of the present invention;

FIGS. 6a and 6b show ring interconnects with an additional signal path for indicating when a data path priority should change;

FIG. 7 shows a plurality of different networks having balanced paths according to an embodiment of the present invention; and

FIG. 8 shows a flow diagram illustrating steps in a method according to an embodiment of the present invention.

### DESCRIPTION OF THE EXAMPLE NO N-LIMITING EMBODIMENTS

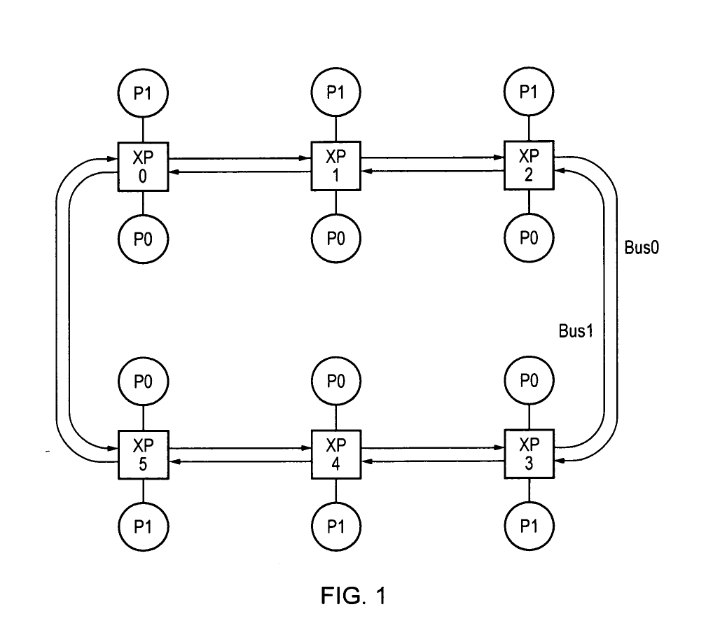

FIG. 1 shows a bufferless ring network that has two data paths flowing in opposite directions bus 0 and bus 1. There are a plurality of nodes XP0 to XP5 at which data packets can enter and exit the network. As there are two data paths at any one node there may be a data packet on each data path that wishes to exit at a particular node and the nodes will have arbiters associated with them in embodiments of the present invention which will prioritise one of the data paths such that where there are contending data packets both wishing to exit at a same time at a same node the data packet on the path that is prioritised will be output and the other data packet will be routed further such that it will travel around the ring again. The arbiter is designed so that when the data packet that has been routed further arrives back at the node where it wishes to output the priority of the data paths will have changed such that it is guaranteed to have priority and will be output this time. The arbiter will have changed the priority independently of the data packet itself but in response to it determining that the required predetermined number of cycles that it takes the packet to travel around the ring have passed. It may determine this in a number of ways that will become clear from later embodiments.

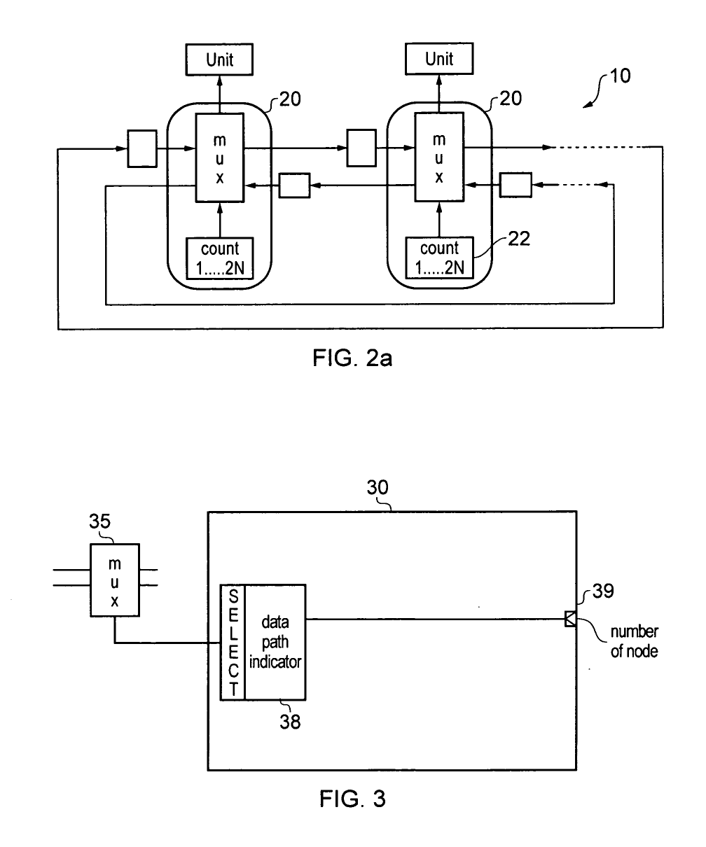

FIG. 2a shows an example of such a ring network 10 with an arbiter 20 at each node. The arbiters have a counter 22 which counts up to a value that is dependent on the number of nodes in the ring and the data path selected is dependent upon the count value. The counter may be designed in a number of ways, for example it may be a modulo N counter that counts up to N and back down again or it may be a modulo 2N counter where the MSB of the counter is used to select the data path. A shift register could also be used.

FIG. 2b shows the minimum number of states and the corresponding amount of storage required to meet the freedom from livelock condition for 2 to 16 pipeline stages with round robin arbitration between the two rings. It should be noted that this is only an example and there are many other different sequences of priority that can be used provided they meet the requirement of the priority being changed when the packet returns to a node. FIG. 2b also shows the pattern of change in prioirty that occurs at each node for the different number of pipeline stages.

As can be seen the count value increases with the number of nodes on the ring and in order to be able to set the sequence up correctly one needs to know the number of nodes that appear on the ring. Where there is an odd number of nodes then the value simply needs to switch each time a data packet appears at a node, however where there are an even number of nodes once during a loop around the priority must not change and thus, the number of nodes in a loop needs to be known and the progress around the ring tracked.

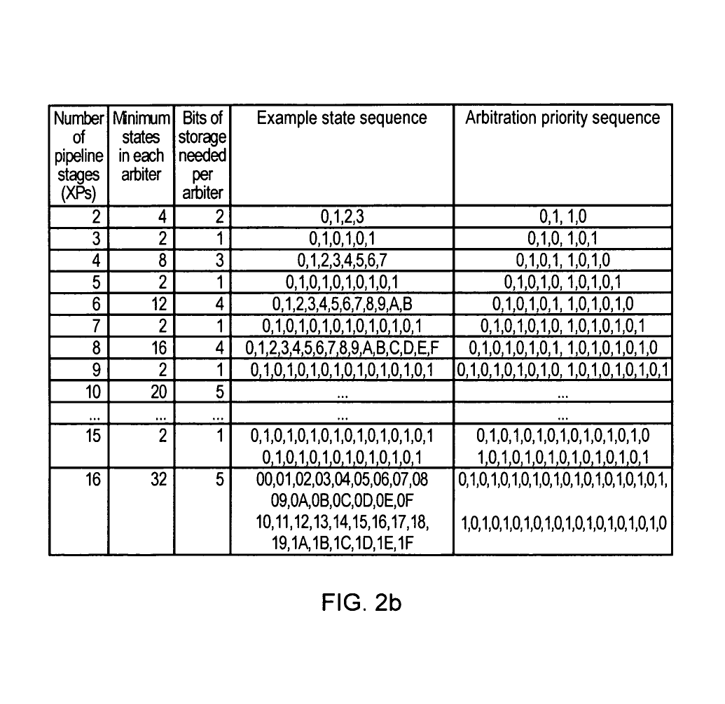

FIG. 3 shows an arbiter 30 according to an embodiment of the present invention having a multiplexer 35 for selecting between data paths and a data path indicator 38 in the form of a counter. There is an input 39 for inputting the number of nodes in the balanced data paths and this is used to set the counter to count to the appropriate value. The value of the counter will indicate the data path to select as is shown with respect to FIG. 2b. Although in this embodiment the number of nodes is input to the arbiter at an input, in other embodiments this information could be programmed by software when the ring is configured. Alternatively, the arbiters could be trained by counting how many cycles it takes for a message to spin around the ring. In these cases the arbiters would need to be configured to be able to store enough state for the largest possible network size. Alternatively, the arbiters could be configured for a particular network and for example where there is an odd number of nodes and two paths then a simple one bit indicator that toggles would be all that was required.

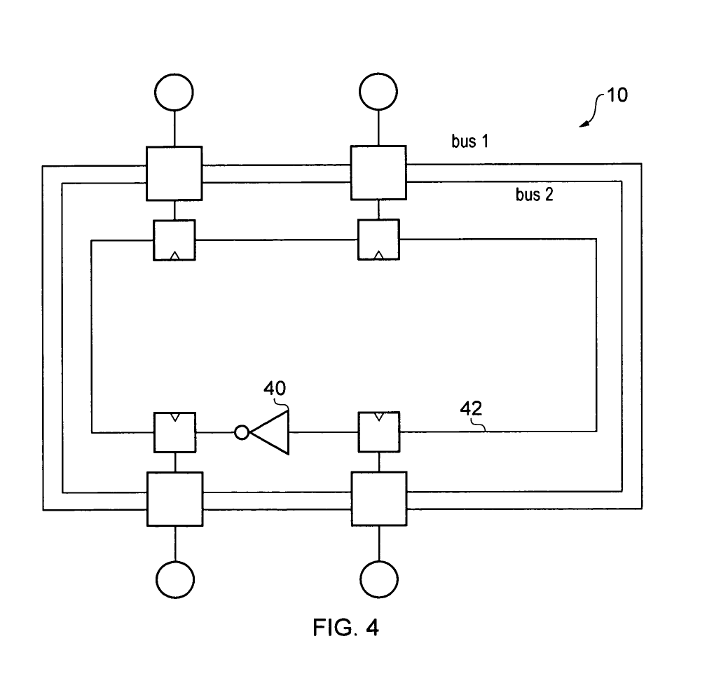

FIG. 4 shows a ring network 10 according to a further embodiment of the present invention where in addition to the two data paths bus1 bus2 there is an additional signal line that transmits a signal along a path 42. Signal path 42 is balanced to the two balanced data paths such that it takes the same time for the signal to travel around the signal line as it does for the data packets to travel around the data paths. In this signal line there is a single inverting device 40 which inverts the signal on the signal line 42 at one point in the ring. This is shown as a simple inverter here but any inverting device would work. In this way, the signal value changes value each time it travels around the ring and as the signal line 42 is balanced to the data paths bus1 and bus2 then each time it changes value the predetermined number of clock cycles that it takes for a data packet to travel round the data paths bus1 and bus2 must have passed. Thus, in response to a change in this signal value the arbiters at the nodes will change the priority of the paths. This ensures that the prioritisation of the data paths happen in synchronisation to the data packets travelling around the data paths and therefore if a data packet is not prioritised for output a first time it hits an output node it will be the next time it arrives at that node.

An advantage of this scheme is that there is no requirement to know the number of nodes on the ring in advance provided that the signal path is balanced to the balanced data paths. In the schemes without the additional signal ring then there is a requirement to have some information regarding the number of nodes in order for the arbitration schemes to work. A disadvantage of the scheme is the hardware cost of the extra signal path.

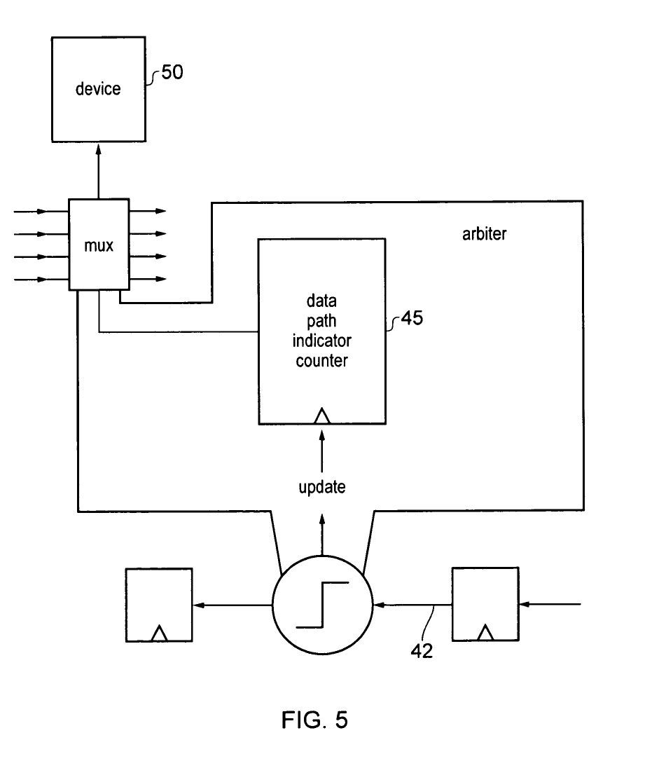

FIG. 5 shows an alternative embodiment in which an arbiter will detect a change in value, in this case a rising edge of the signal value on signal line 42 and in response to this an update signal is sent to the data path indicator counter which indicates which path is prioritised for output to the device 50. The data path indicator counter 45 will prioritise in a round robin way between the four potential data paths. In this embodiment the signal path 42 has registers corresponding to the nodes on the data paths and these registers are loaded with an initial value. In this example, the initial value is set to be consecutive 1's followed by consecutive 0′s such that a rising edge of the signal value will occur once every predetermined number of clock cycles and thus, is an indication that the data path indicator counter should be updated as a data packet will have travelled once around the ring in this time.

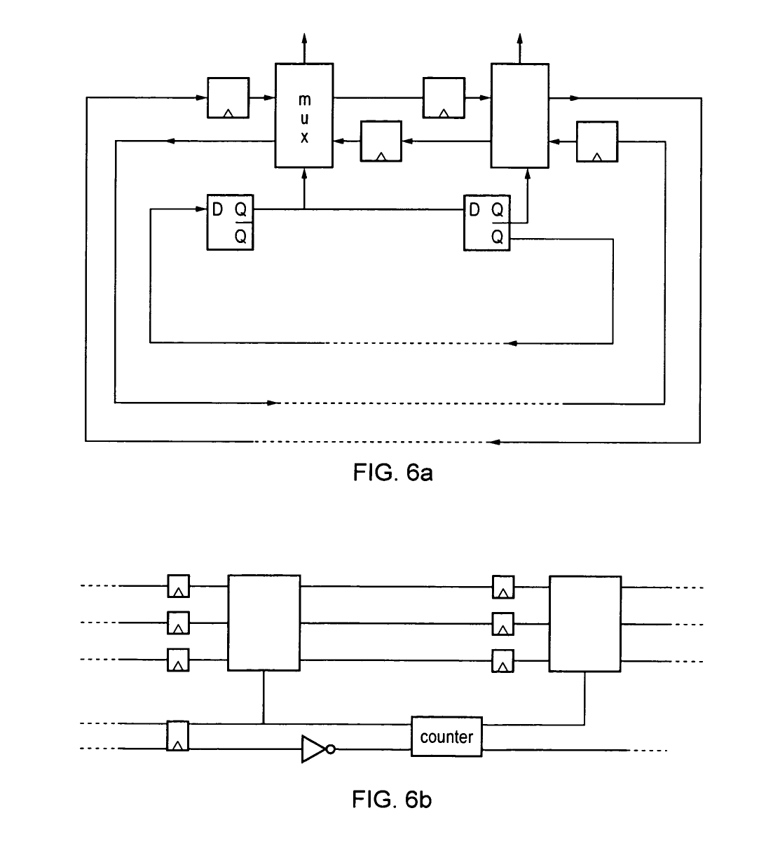

FIG. 6a is an alternative embodiment of the ring network, where a distributed Johnson counter is used to generate the priority inversion signal. In this case the signal line comprises a plurality of d-type registers which act to provide the appropriate delay and to synchronise the signal with the data and also change value once in N cycles where N is the number of registers and in this case the number of nodes. In some embodiments a node may take more than one cycle to process a data packet and in such a case the delay on the signal line and the number of registers will be similarly increased. The inversion that changes the value is achieved by outputting the signal value from one of the d-type registers at the inverted output.

FIG. 6b is a further alternative embodiment of the ring network where there are three data paths and there is a signal path which provides an indication of which of the data paths to select. The signal path has a counter which counts between one and three to indicate the data path and is updated in response to a signal travelling around the ring. This signal may be sent on a separate signal line with an inverter on it, the change in this signal value being an update signal to the counter. This differs to the embodiment of FIG. 5 where each arbiter has a counter which updates in response to a change on the signal path, by having the count value sent round on the signal path. A disadvantage of this is the additional signals that need to be transmitted.

Although the examples shown in FIGS. 1 to 6 have been ring interconnects, any balanced data path where a data packet will return to the node is applicable to embodiments of the present invention.

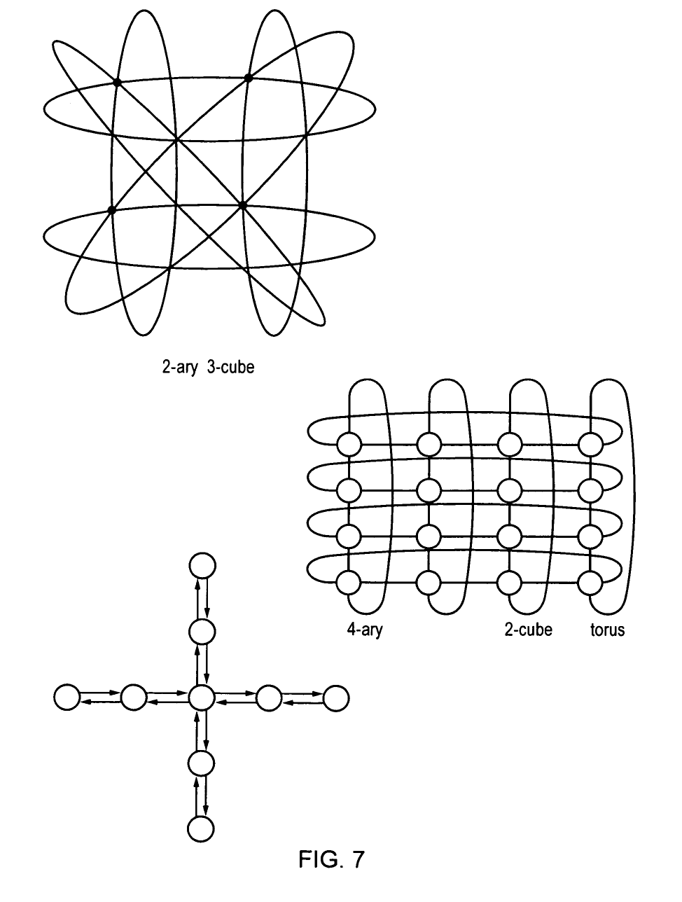

FIG. 7 shows example networks where there are balanced data paths. These may be torus or mesh networks where there are nodes in a regular n-dimensional grid with K nodes in each dimension and channels between nearest neighbours. A ring network would have N equals to 1. These networks are well matched to packaging constraints and at low dimensions they generally have uniformly short wires allowing high speed operation without repeaters.

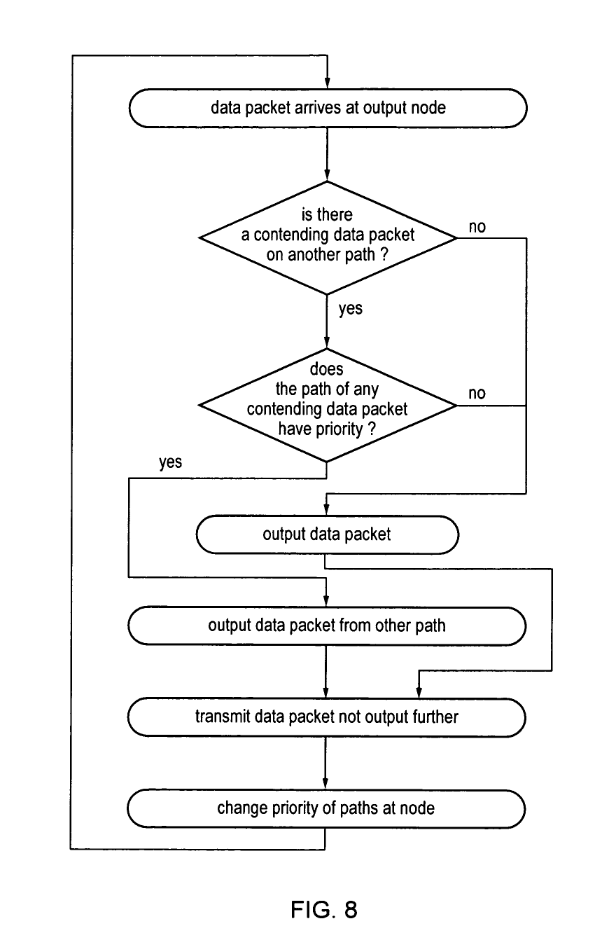

FIG. 8 shows a flow diagram illustrating a method according to an embodiment of the present invention. Initially a data packet will arrive along a data path at an output node and an arbiter at the node will determine if there is a contending data packet on another path. If there is not then the data packet can be output. If there is it will then determine whether the paths of any contending data packet has priority over it. If the path of the contending data packet does have priority then the contending data packet will be output from that path and the received data packet will be transmitted further. The data packet will arrive back at the output node at some point and prior to this the priority of the paths at the node will have been changed such that when the data packet arrives again at the output node the priority of the paths will be different.

Thus, if there is a contending data packet at the output node and there are only two paths one can be sure that the data packet will be output on the second attempt as it will be at this time be on the path with the highest priority. If there are more than two paths then it may not be on the path of the highest priority at the second attempt and if there is a contending data packet on a higher priority path it will have to travel around the loop again until there are no contending data packets on higher priority paths.

Although illustrative embodiments have been described in detail herein with reference to the accompanying drawings, it is to be understood that the claims are not limited to those precise embodiments, and that various changes and modifications can be effected therein by one skilled in the art without departing from the scope and spirit of to the appended claims. For example, various combinations of the features of the following dependent claims could be made with the features of the independent claims.

We claim:

1. An interconnect comprising paths configured to transmit data packets between nodes on a network, said nodes comprising ports for inputting and outputting said data packets to said interconnect;
at least two of said paths each having at least a portion configured such that a data packet addressed for output at one of said nodes on one of said paths and not being accepted at said node will continue along said path and on travelling further will return to said node;
said at least two paths being balanced paths such that a data packet not accepted at said one of said nodes will return to said node a same predetermined number of clock cycles later whichever of said balanced paths said data packet is traveling along;
said one of said nodes comprising an arbiter configured to prioritise one of said balanced data paths for output, said arbiter being configured to ensure that a priority changes after said predetermined number of clock cycles, such that a data packet on any of said balanced paths not being accepted for output at said node on a first attempt is guaranteed to have priority on a subsequent return to said node.

2. An interconnect according to claim 1, wherein each of said balanced paths comprise a same predetermined number of nodes.

3. An interconnect according to claim 1, wherein said arbiter comprises a data store for storing an indicator indicating which of said balanced paths has priority for outputting a data packet, said arbiter being configured to update said indicator to indicate each of said balanced paths in a round robin manner, such that said indicator will indicate a next balanced path in said round robin list after said predetermined number of clock cycles.

4. An interconnect according to claim 1, said interconnect comprising two balanced paths, wherein a data packet on one of said two balanced paths not being accepted for output at said node on a first attempt is guaranteed to have priority on a first return to said node.

5. An interconnect according to claim 4, wherein said arbiter comprises a data store for storing an indicator indicating which of said two balanced paths has priority, said predetermined number of nodes being an odd number and said arbiter being configured to toggle said indicator between receipt of each data packet.

6. An interconnect according to claim 4, wherein said predetermined number of nodes is an even number N, and said arbiter is configured to toggle said indicator between receipt of all but one of every N data packets.

7. An interconnect according to claim 1, said interconnect comprising a signal path balanced with said balanced data paths such that a signal transmitted from said one of said nodes will return to said node said predetermined number of clock cycles later, said arbiter being configured to change a priority of said balanced paths in dependence upon a value of said signal.

8. An interconnect according to claim 7, said signal path comprising a counter configured to count to a value equal to a number of said balanced data paths, said counter updating every predetermined number of clock cycles, a value of said signal indicating said data path to have priority.

9. An interconnect according to claim 7, wherein
said arbiter comprises a data store for storing an indicator indicating which of said balanced paths has priority for outputting a data packet, said arbiter being configured to update said indicator to indicate each of said balanced paths in a round robin manner, such that said indicator will indicate a next balanced path in said round robin list after said predetermined number of clock cycles;
said signal path comprises register stages for holding said signal, said interconnect being configured to preload said register stages with an initial value that is transmitted along said signal path, said arbiter being configured to update said indicator in dependence upon said signal value on said signal path, said initial value being selected such that every predetermined number of clock cycles, said arbiter changes a priority of said balanced data path.

10. An interconnect according to claim 9, wherein said initial value comprises a plurality of consecutive predetermined values, and at least one complementary predetermined value said arbiter updating said indicator in response to said signal switching to one of said predetermined or complementary predetermined value such that it updates once every predetermined number of clock cycles.

11. An interconnect according to claim 7, wherein
said interconnect comprises two balanced paths, wherein a data packet on one of said two balanced paths not being accepted for output at said node on a first attempt is guaranteed to have priority on a first return to said node; and
said signal path is configured to transmit a signal that changes value every predetermined number of clock cycles said arbiter being configured to select one of said two balanced data paths to have priority in dependence upon a value of said signal.

12. An interconnect according to claim 11, said signal path comprising an inverting device configured to invert said signal at one point in said signal path.

13. An interconnect according to claim 4, wherein said interconnect comprises a free flowing ring network and said two balanced paths are parallel paths transmitting packets in opposite directions between a same set of nodes around said ring.

14. An interconnect according to claim 13, wherein each of said nodes around said ring comprises one of said arbiters.

15. An interconnect according to claim 1, wherein said interconnect comprises a k-ary n-cube network, comprising an n dimensional grid with k nodes in each dimension and channels between nearest neighbours, one of said two balanced rings interconnecting said other of said two balanced rings at at least one node.

16. An interconnect according to claim 13, wherein said interconnect comprises a 2-dimensional torus network, one of said two balanced rings interconnecting said other of said two balanced rings at at least one node, said at least one node comprising said arbiter.

17. An interconnect according to claim 1, wherein said interconnect comprises a k-ary, n-mesh.

18. An arbiter configured to select one of at least two data paths at a node on a network for outputting a data packet from, said node comprising ports for inputting and outputting data packets to one of said at least two data paths, each of said at least two data paths having at least a portion configured such that a data packet addressed for output at said node on any of said at least two data paths and not being accepted for output at said node will continue along said data path and on travelling further will return to said node;
said at least two data paths being balanced paths such that a data packet not accepted at said node will return to said node a same predetermined number of clock cycles later whichever of said balanced paths said data packet is traveling along;
said arbiter comprising prioritising circuitry for prioritising one of said data paths for output, said prioritising circuitry being configured to change a priority after said predetermined number of clock cycles, such that a data packet on either of said balanced paths not being accepted for output at said node on a first attempt is guaranteed to have priority on a subsequent return to said node.

19. An arbiter according to claim 18, wherein said arbiter comprises a data store for storing an indicator indicating which of said balanced paths has priority for outputting a data packet, said arbiter being configured to update said indicator to indicate each of said balanced paths in a round robin manner, such that said indicator will indicate a next balanced path in said round robin list after said predetermined number of clock cycles.

20. An arbiter according to claim 18, said arbiter being configured to select one of two balanced paths said arbiter further comprising:
an input for inputting a number of nodes N in said balanced data paths and being configured:
if said number N is an odd number to toggle said indicator indicating which of said two balanced paths has priority between receipt of each data packet; and
if said number N is an even number to toggle said indicator between receipt of all but one of N data packets.

21. An arbiter according to claim 18, comprising an input for receiving a signal from a signal path that is balanced with said balanced data paths such that a signal transmitted from said one of said nodes will return to said node said arbiter being configured to change a priority of said balanced paths in dependence upon said signal on said signal path.

22. A method of selecting one of at least two data paths at a node on a network for outputting a data packet from, said node comprising ports for inputting and outputting data packets to one of said at least two data paths, each of said at least two data paths having at least a portion configured such that a data packet addressed for output at said node on any of said at least two data paths and not being accepted for output at said node will continue along said data path and on travelling further will return to said node;
said at least two data paths being balanced paths such that a data packet not accepted at said node will return to said node a same predetermined number of clock cycles later whichever of said balanced paths said data packet is traveling along;
said method comprising the steps of:
prioritising one of said data paths for output;
changing a priority after said predetermined number of clock cycles, such that a data packet on either of said balanced paths not being accepted for output at said node on a first attempt is guaranteed to have priority on a subsequent return to said node.

23. Interconnecting means comprising paths for transmitting data packets between nodes on a network, said nodes comprising inputting and outputting means for inputting and outputting said data packets to said interconnecting means;
at least two of said paths each having at least a portion configured such that a data packet addressed for output at one of said nodes on one of said paths and not being accepted at said node will continue along said path and on travelling further will return to said node;
said at least two paths being balanced paths such that a data packet not accepted at said one of said nodes will return to said node a same predetermined number of clock cycles later whichever of said balanced paths said data packet is traveling along;
said one of said nodes comprising an arbiter means for prioritising one of said balanced data paths for output, said arbiter means ensuring that a priority changes after said predetermined number of clock cycles, such that a data packet on any of said balanced paths not being accepted for output at said node on a first attempt is guaranteed to have priority on a subsequent return to said node.
